(19) United States
(12) Patent Application Publication
(10) Pub. No.: US 2010/0183050 A1
(43) Pub. Date: Jul. 22, 2010

(54) Method and Apparatus for Providing Satellite Television and Other Data to Mobile Antennas

(75) Inventors: Yoel Gat, Ramat Raziel (IL); Raz Shani, Ra'anana (IL); Danny Spirtus, Holon (IL); Robert Yip, Vienna, VA (US); Mario Gachev, Sofia (BG)

Correspondence Address: D. Kligler I.P. Services LTD, P.O. Box 25, Zippori, 17910, IL

(73) Assignee: RAYSAT INC, Vienna, VA (US)

(21) Appl. No.: 12/718,976

(22) Filed: Mar. 7, 2010

Related U.S. Application Data
(63) Continuation-in-part of application No. 12/496,664, filed on Jul. 2, 2009.
Application No. 12/496,664 is a division of application No. 11/354,246, filed on Feb. 15, 2006, now abandoned.
Application No. 11/354,246 is a continuation-in-part of application No. 11/324,755, filed on Jan. 4, 2006, now abandoned.
Application No. 11/324,755 is a continuation-in-part of application No. 11/074,754, filed on Mar. 9, 2005, now abandoned.
Application No. 11/074,754 is a continuation-in-part of application No. 11/071,440, filed on Mar. 4, 2005, now abandoned.
Application No. 11/071,440 is a continuation-in-part of application No. PCT/US06/04040, filed on Feb. 7, 2006.
(60) Provisional application No. 60/653,520, filed on Feb. 17, 2005.
(60) Provisional application No. 60/650,122, filed on Feb. 7, 2005.

(51) Int. Cl. H04B 1/00

(52) U.S. Cl. 375/138; 375/E01.001

(57) ABSTRACT

A low profile low cost mobile in-motion antenna system for satellite TV reception.

### CROSS REFERENCE TO RELATED APPLICATIONS

The present invention is a continuation-in-part of U.S. application Ser. No. 11/324,755, filed Jan. 4, 2006, entitled System and Method for Low Cost Mobile TV, U.S. application Ser. No. 10/752,088, filed Jan. 7, 2004, entitled Mobile Antenna System for Satellite Communications, U.S. application Ser. No. 11/183,007 filed Jul. 18, 2005, entitled Mobile Antenna System for Satellite Communications, U.S. application Ser. No. 11/074,754, filed Mar. 9, 2005, entitled Method and Apparatus for Providing Low Bit Rate Satellite Television To Moving Vehicles, U.S. application Ser. No. 10/925,937, filed Aug. 26, 2004, entitled System For Concurrent Mobile Two-way Data Communications and TV Reception, U.S. Provisional Application 60/653,520, Filed Feb. 17, 2004, entitled Method and Apparatus for Incorporating an Antenna on a Vehicle, U.S. application Ser. No. 11/071,440, filed Mar. 4, 2005, entitled Low Cost Indoor Test Facility and Method for Mobile Satellite Antennas, U.S. application Ser. No. ______, filed Sep. 6, 2005, entitled Tracking System for Flat Mobile Antenna (PCT/BG2004/000004 filing in U.S. under §371), U.S. application Ser. No. ______, filed Sep. 6, 2005, entitled Flat Mobile Antenna System (PCT/BG2004/000003 filing in U.S. under §371), U.S. application Ser. No. 10/752,088, filed Jan. 7, 2004, entitled Mobile Antenna System for Satellite Communications, U.S. application Ser. No. 11/183,007, filed Jul. 18, 2005, entitled Mobile Antenna System for Satellite Communications, U.S. application Ser. No. ______, filed Oct. 25, 2005, entitled Digital Phase Shifter (PCT/BG2004/000008 filing in U.S. under §371), International Application Ser. No. PCT/BG2004/00011, entitled Flat Microwave Antenna, Filed Jul. 7, 2003, U.S. application Ser. No. 10/498,668, Filed Jun. 10, 2004, entitled Antenna Element, U.S. application Ser. No. ______, (Attorney Docket No. 006681.00070) filed Dec. 30, 2005, entitled Applications for Low Profile Two Way Satellite Antenna System, each of the foregoing applications is hereby specifically incorporated by reference in their entirety herein. With respect to any definitions or defined terms used in the claims herein, to the extent that terms are defined more narrowly in the applications incorporated by reference with respect to how the terms are defined in this application, the definitions in this application shall control.

### BACKGROUND OF THE INVENTION

1. Field of the Invention

The present invention relates to methods and apparatus for providing satellite television and other data broadcasts to mobile platforms such as moving vehicles equipped with antennas that are substantially smaller than would be conventionally used for direct broadcast satellite reception (ultra small mobile satellite antennas). Such antennas would be unobtrusive when mounted atop a vehicle or could be integrated into the vehicles and be invisible from the exterior.

2. Description of the Related Art

Satellite television and data broadcast services from Direct Broadcast Satellites (DBS) operating in the Broadcast Satellite Service (BSS) to homes with stationary antennas comprises well known art. Recently, mobile terminals that can receive such broadcasts on moving vehicles have become a commercial reality. Conventional mobile terminals are designed to operate with the signal strengths and parameters of DBS systems designed to broadcast to homes.

Consequently, these terminals are very large to compensate for their generally low height profile. This is particularly true when the satellite appears at low elevation angles above the horizon as would be the case for a geostationary satellite whose orbital longitude is over the southwest U.S. while the vehicle and mobile terminal are in the northeast parts of the U.S. Fundamental properties of antennas and communications links impose minimum size requirements on these antennas with the consequence that they are, for the U.S. BSS operating parameters in the 12.2-12.7 GHz Ku-band, on the order of 75 cm in diameter. Terminals of this size, while acceptable to those with sport utility vehicles, motor homes, and other relatively large vehicles, are too expensive and too large to be widely used on automobiles or by OEMs for integration into the car's structure.

### SUMMARY OF THE INVENTION

One solution for satellite broadcasting to smaller terminals is to launch one or more BSS satellites with substantially higher radiated power. This may be possible in ITU Region 2 (north and south America) where there is no imposed limit on the radiated spectral power density. Nevertheless, the practical reduction in terminal size can be limited by such factors such as the tradeoff between satellite and launch costs, which are proportional to the satellite's power and bandwidth, and the mobile terminal cost, which in generally inversely proportional to the received power.

A brute force increase in satellite radiated power is one solution to reducing mobile antenna dish size, but it has certain challenges such as maintaining a cost effective solution to the overall system. Furthermore, in other ITU Regions, power spectral density limits do exist, thereby limiting the available downlink power for conventional broadcasts. As the mobile terminals are reduced in size, fundamental antenna properties dictate that they will have broader reception beams and be more susceptible to interference from adjacent satellites, from both co-polarized and cross polarized transmissions which are also in the same frequency bands.

These issues are most severe for satellite broadcast in the Fixed Satellite Service (FSS). For example, these satellites operate in the U.S., at the frequencies 11.7-12.2 GHz and they are spaced approximately 2° apart in longitude in the geostationary orbit. These satellites have severe restrictions on their allowable radiated spectral power density from space to earth. The practical consequence is that, for conventional transmissions and capacity utilizations, the mobile terminals must be at least as large as those for use in the BSS. (Such terminals have the additional burden of operating with linear polarizations which must be continually adjusted depending on the vehicle orientation.)

In aspects of the invention, a method and associated apparatus is provided that allows satellite transmissions to small, inexpensive mobile terminals while maintaining transmission power spectral density limits and providing interference protection from adjacent satellite copolarized and cross polarized transmissions

Objectives of the invention include providing a method and apparatus for mobile satellite broadcast to mobile antennas that are relatively flat, have smaller size, have lower cost, could be easily embedded in the car roof (ultra small mobile antennas), and have robust reception of the intended signals in the presence of strong interference.

In aspects of the present invention, these objectives may be achieved by a dedicated satellite transmission system that incorporates spread spectrum techniques for satellite transmission of high quality video and data to mobile terminals. The method may include spreading of the spectrum of the transmission over a wider frequency band, for example, up to the full bandwidth of a satellite transponder, in order to utilize all of the transponder's power while keeping the power spectral density (PSD) relatively low in order to comply with regulations at the expense of bandwidth efficiency. The method also allows for lower adjacent satellite interference due to the inherent processing gain feature in spread spectrum systems enabling interference reduction. Interference reduction is achieved by exploiting the properties of spread spectrum systems, for example, to first multiply the desired signal by a unique spreading code such as a pseudorandom sequence upon transmission, and then, upon reception the receiver “despreads” the desired signal by using the same code to achieve a high correlation with the desired signal while providing a high degree of rejection of signals that do not correlate with the intended code.

The present invention provides methods and apparatus for satellite broadcast of high quality satellite television and other data to moving vehicles with small terminals. The method may include spreading the spectrum of video or data channels in the transponders so that the full power of the transponder can be made available even for a low bit rate carrier thereby reducing the required size of the reception terminals. The spreading broadens the bandwidth of the transmitted signal in order to keep the spectral density within regulatory limits. In systems according to the present invention, although the satellite transponders operate at substantially reduced capacity, the mobile antenna size and cost is substantially reduced, making this system practical for large scale deployment.

For example, a conventional BSS satellite using MPEG 2 signal compression can transmit more than 12 standard definition TV channels in a transponder with 24 MHz bandwidth (this capacity will increase with MPEG 4). However, the reception terminal generally would have an effective area approximately equivalent to a 45 cm dish. To transmit successfully to a much smaller aperture, each channel must have more of the transponder's available power (typically 100-200W). Then, since the same power is being used for fewer channels, the power density, i.e. the W/MHz for each channel is higher. With conventional modulation such as QPSK and 8PSK, the fewer signals only occupy a fraction of the transponder bandwidth and the equivalent isotropically radiated power (EIRP) spectral density may exceed regulatory limits.

However, by using spreading, a much smaller mobile antenna may be used to receive the stronger signals and not be nearly as susceptible to interference. By spreading the fewer signals over the entire transponder bandwidth, the spectral density is reduced and yet the full power of the transponder is used for the signals, allowing for reception by terminals that may be only 20 cm in diameter or less and, with suitable use of phased array technology, may be only 2.5 cm high or less. The tradeoff is that the transponder capacity may now be limited to only a few, e.g. 1-4 standard definition TV channels.

In other application, the use of spread spectrum methods and their properties is well known. The subject invention describes the unique embodiments and overall system to apply spread spectrum techniques to the broadcast of satellite video and data to small mobile terminals. Each example embodiment addresses issues unique to the satellite TV broadcast system. These issues include: spreading of all signals radiating for a satellite such that the mobile receivers may acquire and tune quickly among them; combinations of spreading and satellite spot beams; spatial and time diversity using multiple satellites; and use of terrestrial transmissions to supplement and “fill” coverages in urban environments. The embodiments described below will be understood to exemplify the methods and apparatus.

One embodiment is to spread the signals in the feeder uplink ground station, which comprises a set of parallel channels to process the signals provided by the plurality of base band video sources. Each of the channels may include source signals that have been compressed or encoded using standard methods such as MPEG 4, MPEG 2, MPEG 4 HD Windows Media 10, or other similar techniques. Currently, MPEG 2 is common, but MPEG 4 has many advantages.

A number of compressed video signals are combined and destined for one transponder. At the same time, other groups are combined and destined for other transponders on, for example, a dedicated satellite. The signals are processed with Forward Error Correction and modulated for transmission to the satellite using, for example, the transmission standards; DVB S, DVB S2 or other similar technique. For the parallel processing in this embodiment, all transponder channels may be spread over a wide bandwidth by being multiplied by same direct sequence generator at the same time. The signals may then be combined, upconverted and sent to the satellite. The mobile receiver can now switch channels among all the transponders almost instantly because it is already “tuned” to the same sequence whereas, if each transponder used a different spreading sequence, the receiver might take several seconds to synchronize to a signal from another transponder. The use of the same spread spectrum direct sequence in the same exact timing, in the uplink or in the satellite, guarantees that the acquisition time will be short because the subscriber is already locked on the sequence.

Another embodiment is to incorporate signal processing on the satellite. In this preferred embodiment a standard DVB modulated signal received by the satellite receiving antenna is divided by a switching matrix and a proper power dividing circuit to a set of parallel channels sampled by the same exact direct sequence generator that could use several types of sequences for example 7, 15, 31 chips per bit. In another exemplary embodiment the direct sequence generator may be bypassed by ground command. The signals in each channel then may be amplified, combined and then delivered to the satellite transmit antenna. The transmit signal is then received by subscriber's terminals and despread and decoded by the subscriber's receiver.

In another preferred embodiment, a set of terrestrial repeaters may be used in order to support service in areas when a direct line of site to the satellite selected for communication is not available, such as within a city where no line of site is available. The system in accordance with this aspect of the invention may utilize terrestrial repeaters. These repeaters may be variously configured, and in some embodiments, may operate in the Ku band at the same exact frequency of the satellite. In this case, there is often a need to change the spread spectrum direct sequence such that the sequence in the satellite which is received in the repeater and the spread spectrum sequence in the terrestrial radiated signal will be different so that no oscillations will occur if the received and transmit signal in the repeater will be identical.

### BRIEF DESCRIPTION OF THE DRAWINGS

Embodiments of the invention are described below in detail with reference to the following drawings in which like reference numerals refer to like elements wherein:

FIGS. 1a and 1b Illustrate the spreading technique used according embodiments of the invention;

FIG. 2 illustrates the block diagram of the de-spreading process in the subscriber's receiver according embodiments of the invention;

FIG. 3 illustrates the spreading process in the ground station according to embodiments of the invention;

FIG. 4 illustrates a block diagram of a spreading process on the satellite's according another embodiment of the invention;

FIG. 5 illustrates schematically the mobile communication using a small size subscriber antenna according to embodiments of the invention;

FIG. 6 illustrates the block diagram of the subscriber's terminal wherein terrestrial repeaters working in Ku band are used according embodiments of the invention;

FIG. 7 illustrates the block diagram of the subscriber's terminal wherein terrestrial repeaters working in L band are used according to embodiments of the invention;

FIG. 8 illustrates the implementation of an additional outer coding technique in order to avoid signal short fades;

FIGS. 9-20 illustrate exemplary configurations in accordance with the present invention of the ultra small mobile satellite terminal.

### TECHNICAL DESCRIPTION OF THE INVENTION

The following describes in detail exemplary embodiments of the invention, with reference to the accompanying drawings.

The claims alone represent the metes and bounds of the invention. The discussed implementations, embodiments and advantages are merely exemplary and are not to be construed as limiting the present invention. The description of the present invention is intended to be illustrative, and is not intended to limit the scope of the claims. Many alternatives, modifications and variations will be apparent to those skilled in the art.

Aspects of the present invention provide a system and method for providing low cost, low profile, mobile satellite antennas for use with satellite television transmission. [15] Hereinafter, in describing the structure and operations of an apparatus for providing satellite television to moving vehicles with small terminals according to the present invention.

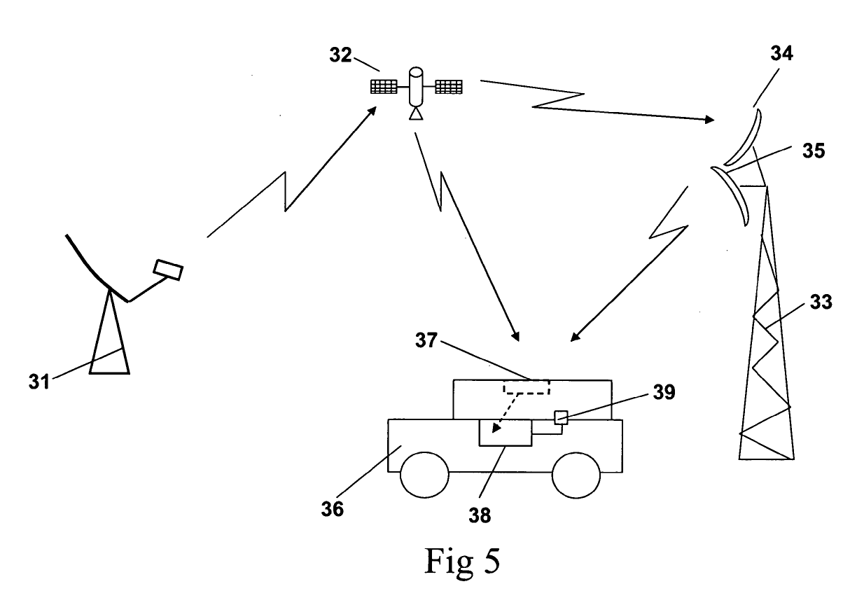

Aspects of the present invention relate to satellite TV and data services directed toward cars including aftermarket & OEM. The invention comprises a system shown in FIG. 5 wherein a hub feeder station 31 transmit the properly processed signal toward a selected satellite 32 (e.g., geostationary) in order to achieve a signal strength in the downlink to be received by an ultra small size antenna for example with a diameter/cross section less than 20 cm. In one embodiment of the invention the signal processing (e.g., spreading) may be done on the satellite 32. In this embodiment, standard DVB signals are transmitted by the hub station. The signal retransmitted by the satellite 32 is than received by a low profile small size antenna 37. In one preferred embodiment of the invention the antenna may be embedded in the car roof.

The antenna 37 may be a flat antenna array with fully electronic steering. In other preferred embodiments, the antenna may have mechanical or semi mechanical semi electronically beam steering in order to track the satellite, while the vehicle is moving. The antenna 37 is connected, to the indoor equipment. The indoor equipment may comprise an antenna control box integrated with the satellite receiver 38 and user interface. The receiver 38 is connected to the user equipment 39 for example rear seat entertainment, TV screen or laptop. In one preferred embodiment of the invention the connection between the antenna 37 and the receiver 38 and between the receiver 38 and the subscribers equipment 39 may be wireless. The antenna 37 may receive signals from a terrestrial repeater 33. The repeater may be a part of a set of terrestrial repeaters arranged to ensure communication in areas where it is not possible to have a clear line of site toward the selected for communication satellite. The repeater may be arranged on a tower or on the roof of a tall building in order to have a clear line of sight toward the selected for communication satellite 32. The repeater 33 may be configured to receive the satellite signal through the receiving antenna 34 and then retransmit it using a transmit antenna 35 toward the shaded area.

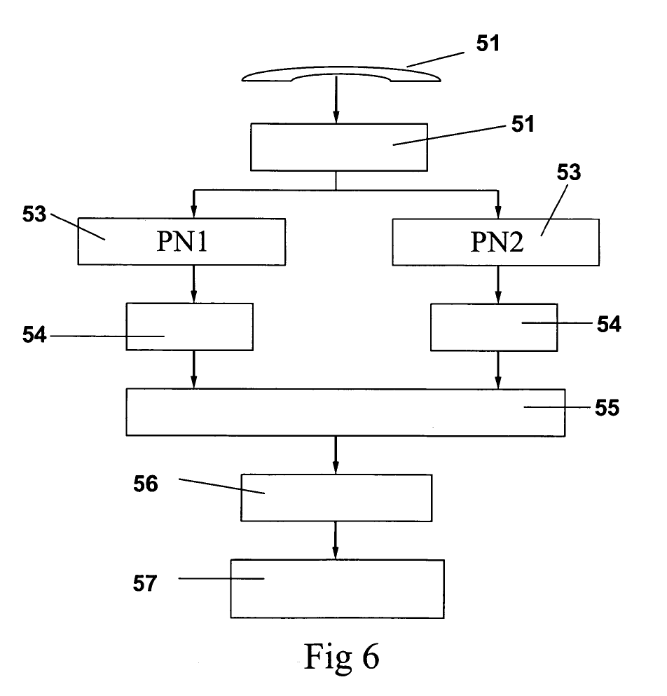

In one preferred embodiment the satellite transmitter and the terrestrial transmitter may transmit at the same frequency in Ku band, since a spread spectrum technology is used. The satellite and the repeater may transmit the same data (video), but using different PN codes for spreading the signal referring to FIG. 6 where the embodiment is illustrated. The Ku band signals coming from a terrestrial repeater and (or) from the satellite are received by subscribers, mobile antenna 51, down converted by built in downconverter and then delivered to the L band tuner 52, then the signal is spited and despread in parallel in two despreaders 53 using different PN sequences, each one dedicated to the satellite or terrestrial repeater signals. In one exemplary embodiment the two despread signals are processed by the receivers 54 and then compared in a signal level detector 55. The selected stronger signal is delivered to a video decoder 56 and then to the subscriber's video display 57.

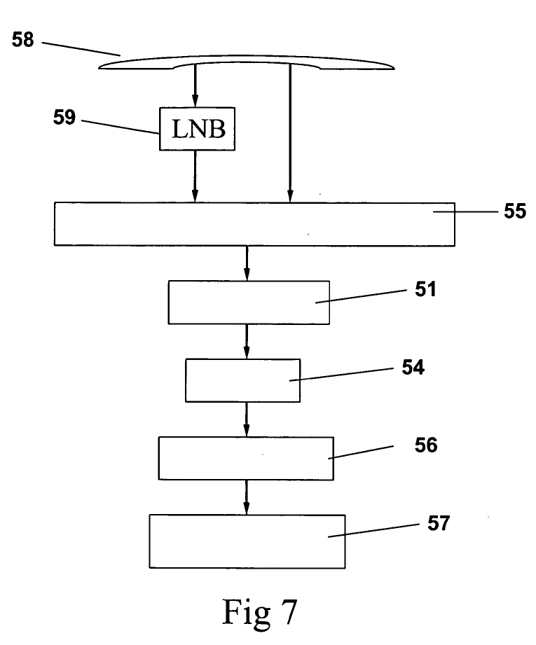

In another preferred embodiment, illustrated in FIG. 7 the terrestrial repeaters radiate signals in L band, and a subscriber's terminal may be supplied with two antennas 58 for Ku band satellite signals and for example, L band terrestrial repeater signals. The Ku band satellite signals are downconverted by a LNB (Low Noise Block). In other embodiments, the LNB may be integrated into the antenna. The two L band signals (Downconverted satellite signal and L band terrestrial repeater signal) may then be compared in a signal level detector 55 and the stronger one is selected for further processing in L band tuner 51 and receiver 54. The signals from the receiver 54 may then be output in a video detector 56 and displayed on the subscriber's screen 57.

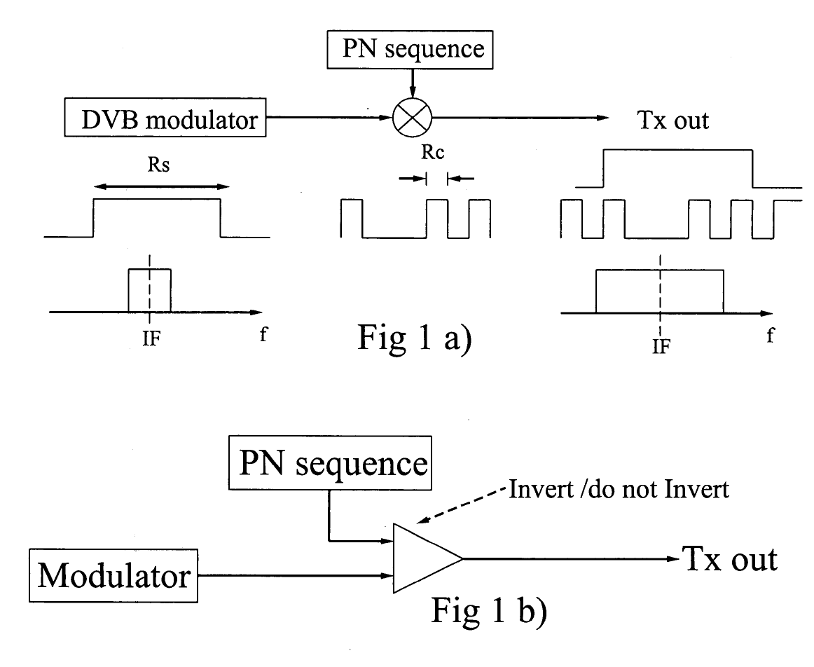

FIG. 1a) illustrates one preferred spread spectrum technique, which may be implemented according embodiments of the invention, for example, by multiplying the DVB signal by a PN (pseudo noise) sequence 1, −1. The length of the pseudo noise sequence may be 3,7,15,31, , , , (2n-1). The chip rate Rc determines the bandwidth of the spread signal BW=1/Rc and the processing gain Rc/Rs. One simple embodiment of the spread spectrum technique is illustrated on FIG. 1b) wherein as the sequence of +1, −1 may be used, the multiplier can be implemented using an inverter amplifier.

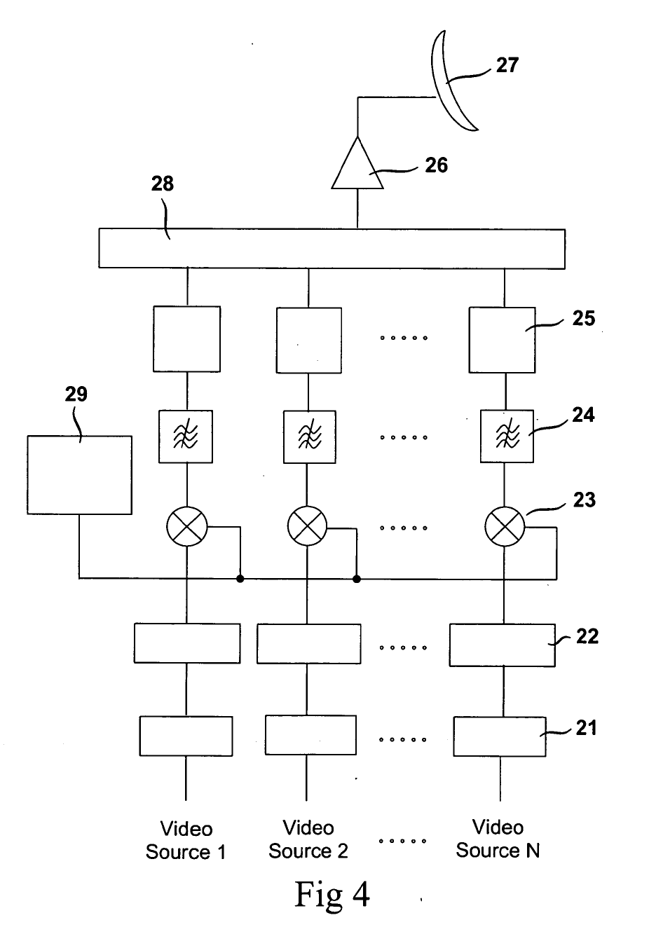

FIG. 4 illustrates one preferred embodiment of the signal processing in the uplink. In one exemplary embodiment it may be done using the equipment of the hub station wherein a set of video signal sources are connected to the set of encoders 21. The set of source encoders 21 may compress the source signals using for example MPEG 4, MPEG 2 ,HD or another similar coding standard. Then the compressed signals may be transferred to the set of modulators 22 which modulates the set of signals according to DVB S, DVBS2 or another proper modulation and forward error correction standard. The modulated signals may then be spread using a set of multipliers 23 and a direct sequence generator 29 and then through the set of filters 24 are upconverted using a set of upconverters 25 to form a set of transmit signals. The transmit signals are combined in combining device 28, amplified in the high power amplifier 26 and transmitted by hub antenna 27 toward selected satellite.

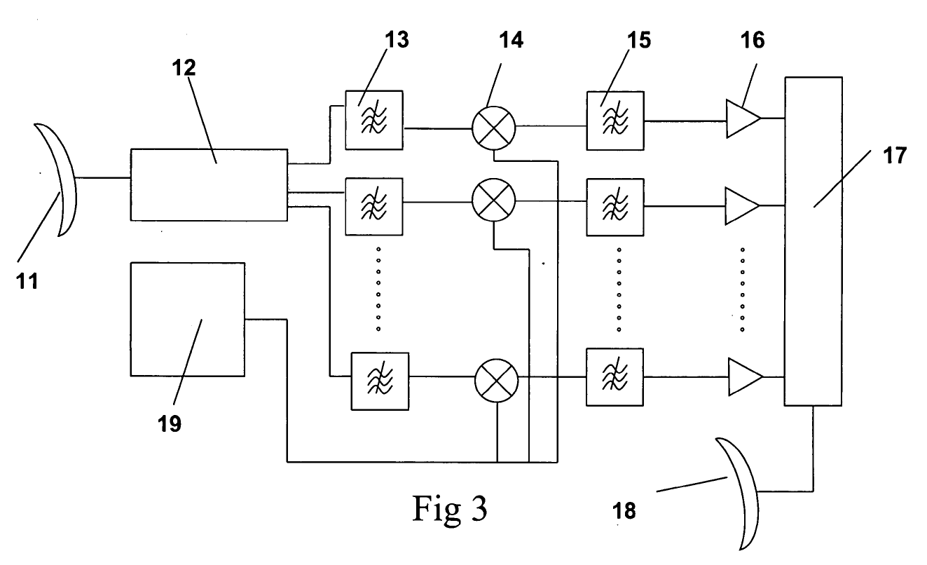

FIG. 3 illustrates another preferred embodiment of the signal processing, processing on satellite. A standard DVB signal, transmitted by a ground hub station is received by a satellite-receiving antenna and then divided to a set of signals using a proper switching matrix and dividing circuit 12. The set of signals a re then transferred through the set of filters 13 and spread using set of multipliers 14 and a direct sequence generator 19. Then the spread signals are transferred through the set of filters 15 amplified in the amplifiers 16 and combined in a combining circuit 17. The combined signal is then transmit by the antenna 18 to form a spot beam on the earth surface having enough power to be received by small, mobile subscriber's antennas.

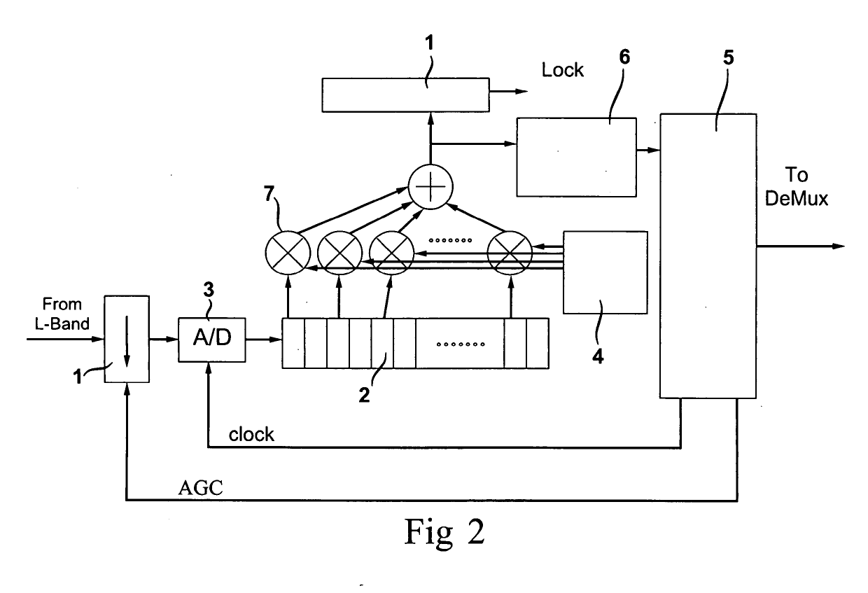

FIG. 2 illustrates an exemplary dispreading process in the subscriber's receiver. The received by small mobile antenna spread spectrum signal is down converted by the built-in LNB (Low noise block) to first intermediate frequency in L band and transferred to a DVB RF front end 1 of the specialized satellite receiver and downconverted to the second intermediate frequency. Then the signal is sampled by A/D device 3 and feed to a shift register 2. In one preferred embodiment the sampling frequency is 2*Rc (chip rate). The shift register odd (or even) outputs are multiplied by the PN (pseudo noise) sequence and summed in the summation device 8 and feed to the threshold detector 9. If the summation exceeds a threshold the receiver is declared locked and then the sum signal is feed to an off-the-shelf DVB receiver 5 via a D/A 6 or in another preferred embodiment digitally. In one exemplary embodiment the time tracking may be done using an early-late algorithm.

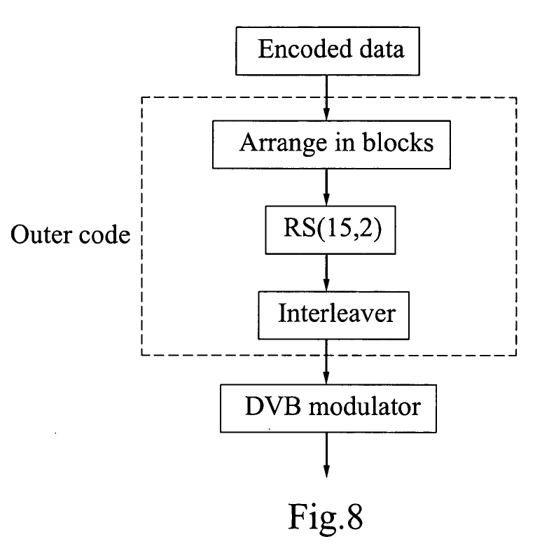

In another preferred embodiment of the invention an additional outer coding technique may be implemented in order to avoid short fades or blockages of the signal, FIG. 8 illustrates the block diagram of one example of a preferred embodiment of the additional outer coding technique applied to the transmit signal. [We could also refer to off the shelf techniques for recovery of blocked signals by FEC and interleaving methods offered by Digital Fountain or KenCast].

The additional outer code should me much longer then the length of the fade. For example a Reed Solomon outer code RS(15,2) may be used. The Reed Solomon code can fix any erroneous block inside a received 15 blocks. If the blocks of 1 sec are used, then the RS code could fix any 1 sec of fade inside any 15 sec of reception.

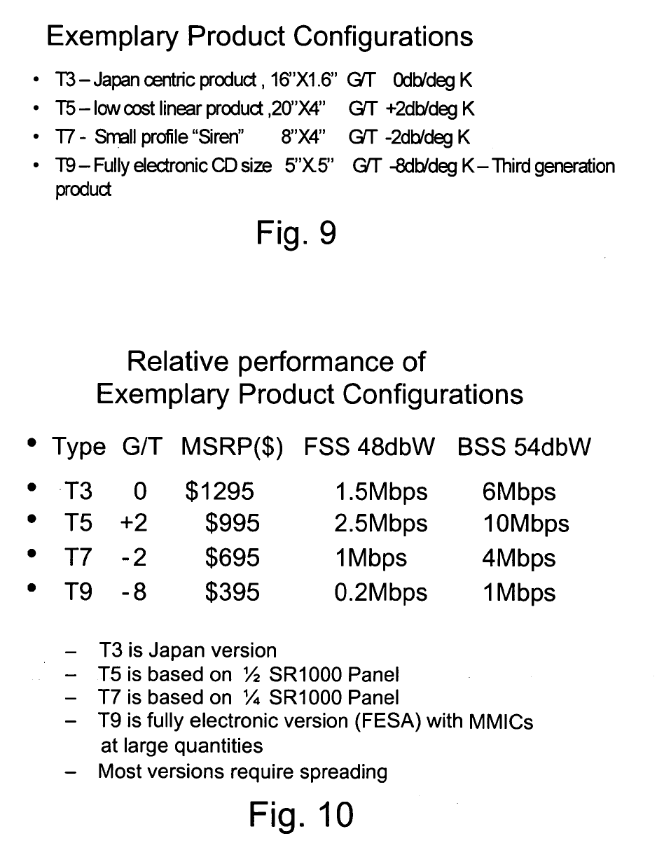

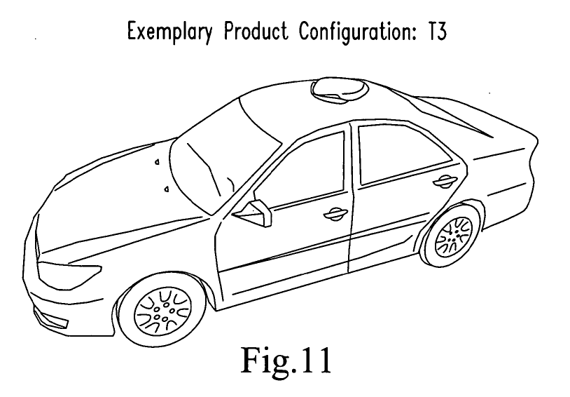

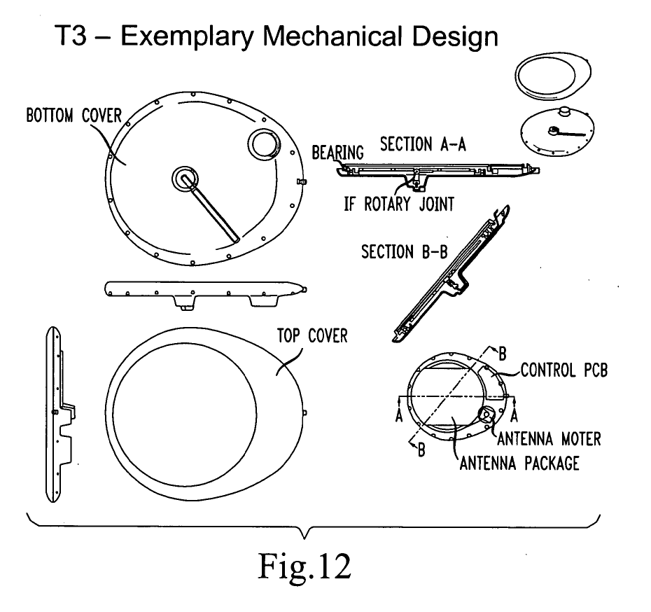

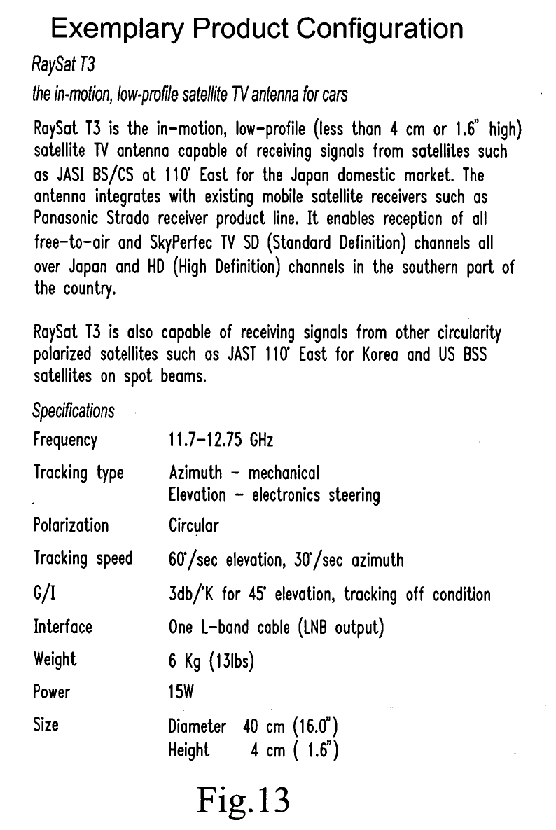

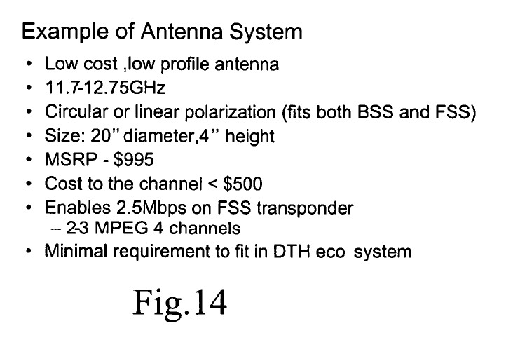

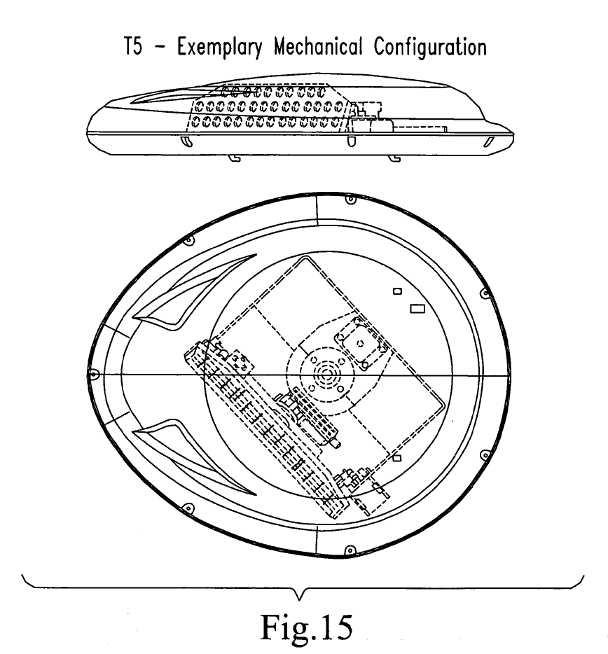

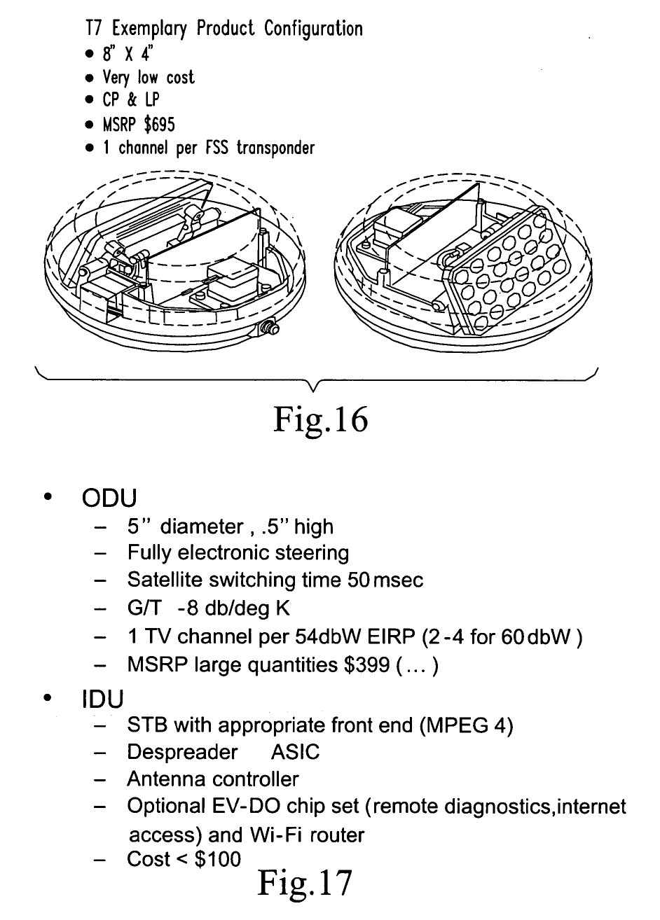

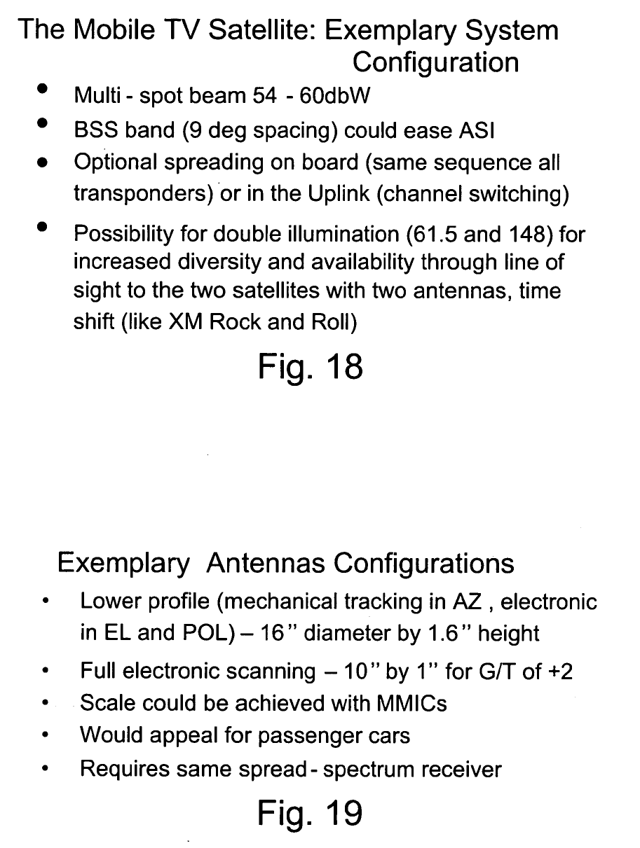

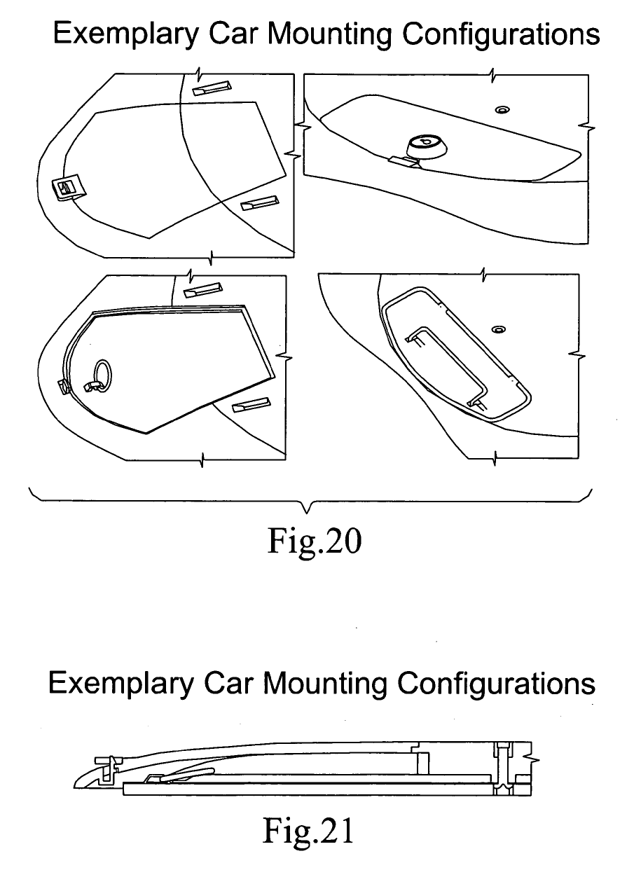

Embodiments of the invention have substantial advantages and allow configurations that have never before been possible using conventional mobile transmission systems. For example, FIGS. 9-20 illustrate numerous configurations of the ultra small satellite mobile terminal enabled by the present invention. It is specifically contemplated that these examples form a part of the invention.

The use of spectrum spreading allows the use of small antennas in a high interference environment by limiting the Power Spectral Density (PSD) of the carrier to levels acceptable to the FCC. Small antenna are desirable from an aesthetics perspective especially on vehicles, however smaller antennas have lower gain to noise temperature ratios (G/T) and suffer greater levels of interference from adjacent satellites. To overcome the limitations the downlink PSD level must be high, however FCC and coordination limitations set the PSD levels. To overcome this limitation the use of spread spectrum is often useful.

An example of the antenna size, G/T, and maximum data rates are shown in the table below assuming operation with typical FSS and BSS satellites.

| Antenna Size | Antenna G/T | | Maximum Data Rate |
|---|---|---|---|
| 12.6 cm × 12.6 cm | −4.0 | dB/K | 1024 kbps |
| 17 cm × 17 cm | −2.6 | dB/K | 1340 kbps |
| 22.4 cm × 22.4 cm | 0 | dB/K | 2100 kbps |
| 28 cm × 28 cm | 2.0 | dB/K | 3000 kbps |

The foregoing embodiments and advantages are merely exemplary and are not to be construed as limiting the present invention. The description of the present invention is intended to be illustrative, and is not intended to limit the scope of the claims. Many alternatives, modifications, and variations will be apparent to those skilled in the art.

1-16. (canceled)

17. A method for communication, comprising:
applying a single spreading code to first and second input data, so as to produce respective first and second spread-spectrum signals;
transmitting the first and second spread-spectrum signals via respective first and second satellite transponders;
at a mobile terminal, receiving the first spread-spectrum signal from the first satellite transponder, and reconstructing the first input data by synchronizing to the single spreading code; and
switching the mobile terminal from receiving the first spread-spectrum signal from the first satellite transponder to receiving the second spread-spectrum signal from the second satellite transponder, and reconstructing the second input data while remaining synchronized to the single spreading code.

18. The method according to claim 17, wherein transmitting the first and second spread-spectrum signals comprises coordinating a relative timing of the first and second spread-spectrum signals.

19. The method according to claim 17, wherein applying the single spreading code comprises applying the spreading code in a satellite that includes the first and second satellite transponders.

20. The method according to claim 17, wherein each of the first and second satellite transponders has a bandwidth, and wherein applying the single spreading code comprises producing the first and second spread-spectrum signals so as to fully occupy the bandwidth.

21. The method according to claim 17, wherein the first and second input data comprise video transmissions.

22. A communication apparatus, comprising:
a transmitter, which is arranged to apply a single spreading code to first and second input data so as to produce respective first and second spread-spectrum signals, and to transmit the first and second spread-spectrum signals via respective first and second satellite transponders; and
a mobile terminal, which is arranged to receive the first spread-spectrum signal from the first satellite transponder, to reconstruct the first input data by synchronizing to the single spreading code, to switch from receiving the first spread-spectrum signal from the first satellite transponder to receiving the second spread-spectrum signal from the second satellite transponder, and to reconstruct the second input data while remaining synchronized to the single spreading code.

23. The apparatus according to claim 22, wherein the transmitter is arranged to coordinate a relative timing of the first and second spread-spectrum signals.

24. The apparatus according to claim 22, wherein the transmitter is comprised in a satellite that further comprises the first and second satellite transponders.

25. The apparatus according to claim 22, wherein each of the first and second satellite transponders has a bandwidth, and wherein the transmitter is arranged to apply the single spreading code such that the first and second spread-spectrum signals fully occupy the bandwidth.

26. The apparatus according to claim 22, wherein the first and second input data comprise video transmissions.

27. A communication apparatus, comprising:
an antenna, which is operative to receive via first and second satellite transponders respective first and second spread-spectrum signals, which are produced by applying a single spreading code to respective first and second input data; and
a receiver, which is arranged to reconstruct the first input data by synchronizing to the single spreading code, to switch from receiving the first spread-spectrum signal from the first satellite transponder to receiving the second spread-spectrum signal from the second satellite transponder, and to reconstruct the second input data while remaining synchronized to the single spreading code.
